(19) United States
(12) Patent Application Publication
(10) Pub. No.: US 2024/0363872 A1
(43) Pub. Date: Oct. 31, 2024

(54) SOLID OXIDE CELL

(71) Applicant: SAMSUNG ELECTRO-MECHANICS CO., LTD., Suwon-si (KR)

(72) Inventors: Hyeg Soon An, Suwon-si (KR); Bon Seok Koo, Suwon-si (KR); Su Beom Park, Suwon-si (KR); A Reum Jun, Suwon-si (KR); Jung Hyun Lee, Suwon-si (KR); Jae Seok Yi, Suwon-si (KR)

(73) Assignee: SAMSUNG ELECTRO-MECHANICS CO., LTD., Suwon-si (KR)

(21) Appl. No.: 18/227,603

(22) Filed: Jul. 28, 2023

(30) Foreign Application Priority Data
Apr. 28, 2023 (KR) 10-2023-0056036

(51) Int. Cl. H01M 4/86; C25B 1/04; C25B 9/19; C25B 11/03; H01M 8/1246

(52) U.S. Cl. CPC H01M 4/8626; C25B 1/04; C25B 9/19; C25B 11/03; H01M 8/1246; H01M 2008/1293

(57) ABSTRACT

A solid oxide cell includes a fuel electrode, an air electrode, and an electrolyte disposed between the fuel electrode and the air electrode. The fuel electrode includes a plurality of pore arrays arranged in a first direction. One of the plurality of pore arrays includes a plurality of pores arranged in a second direction. The first direction refers to a thickness direction of the electrolyte, and the second direction refers to a direction perpendicular to the first direction.

### CROSS-REFERENCE TO RELATED APPLICATION(S)

This application claims benefit of priority to Korean Patent Application No. 10-2023-0056036 filed on Apr. 28, 2023 in the Korean Intellectual Property Office, the disclosure of which is incorporated herein by reference in its entirety.

### TECHNICAL FIELD

The present disclosure relates to a solid oxide cell.

### BACKGROUND

A solid oxide fuel cell (SOFC) and a solid oxide electrolysis cell (SOEC) include a cell including an air electrode, a fuel electrode, and a solid electrolyte having oxygen ion conductivity, and here, the cell may be referred to as a solid oxide cell. The solid oxide cell produces electrical energy through an electrochemical reaction or electrolyzes water through a reverse reaction of a solid oxide fuel cell to produce hydrogen. Compared to other types of fuel cells or water electrolysis cells, such as phosphoric acid fuel cells (PAFC), alkali fuel cells (AFC), polymer electrolyte membrane fuel cells (PEMFC), and direct methanol fuel cells (DMFC), solid oxide cells have a low overvoltage based on low activation polarization has less irreversible loss, thus having high efficiency. In addition, since solid oxide cells may be used as a fuel of carbon or hydrocarbon, as well as hydrogen, thereby having a wide range of fuel selection, and solid oxide cells do not require expensive precious metals as an electrode catalyst due to a high reaction rate thereof in electrodes.

The solid oxide cells generally have a structure in which an electrolyte is disposed between electrode layers, and a reaction to function as a battery occurs in the electrode layer. In order for the reaction to take place effectively in the electrode layer, gas has to be able to pass therethrough easily, and to this end, a technique of forming the electrode layer as a random-shaped porous body has been known.

### SUMMARY

Exemplary embodiments provide a highly reactive solid oxide cell by providing smooth gas flow.

According to an aspect of the present disclosure, a solid oxide cell includes: a fuel electrode; an air electrode; and an electrolyte disposed between the fuel electrode and the air electrode. The fuel electrode includes a plurality of pore arrays arranged in a first direction. One of the plurality of pore arrays include a plurality of pores arranged in a second direction. The first direction refers to a thickness direction of the electrolyte, and the second direction refers to a direction perpendicular to the first direction

In the one of the plurality of pore arrays, the plurality of pores may also be arranged in a third direction to form a grid structure, the third direction referring to a direction perpendicular to the first direction and the second direction.

In the one of the plurality of pore arrays, the plurality of pores may be arranged on substantially the same level with respect to the first direction.

The plurality of pores may include pores having a shape in which a width in the second direction or a third direction narrows toward the electrolyte in the first direction, the third direction referring to a direction perpendicular to the first direction and the second direction.

The plurality of pores may include pores having a shape in which a maximum length in the second direction and a maximum length in a third direction are substantially the same, the third direction referring to a direction perpendicular to the first direction and the second direction.

The plurality of pores may include a hemispherical pore.

The plurality of pores may include a first line pore having a shape in which a maximum length in a third direction is twice or more a maximum length in the second direction, the third direction referring to a direction perpendicular to the first direction and the second direction.

In the one of the plurality of arrays, the first line pore may be provided in plural, and the plurality of first line pores are regularly arranged in the second direction.

In the one of the plurality of arrays, the plurality of pores may include a second line pore having a shape in which a maximum length in the second direction is twice or more a maximum length in the third direction.

The second line pore may be provided in plural, and the plurality of second line pores are regularly arranged in the third direction.

The first line pore and the second line pore may cross each other.

The fuel electrode may include a protrusion partially disposed in the plurality of pores.

The protrusion may overlap some of the plurality of pores in the first direction.

When a distance between adjacent pore arrays in the first direction in the plurality of pore arrays is t and a maximum length of the pore in the second direction is d, d may be greater than t.

d may be equal to twice or more of t.

The plurality of pore arrays may be three or more pore arrays and are regularly arranged in the first direction.

Among the plurality of pore arrays, a pore array closest to the electrolyte in the first direction may be spaced apart from the electrolyte in the first direction.

Among the plurality of pore arrays, a pore array farthest from the electrolyte in the first direction may be embedded in the fuel electrode.

Among the plurality of pore arrays, a pore array farthest from the electrolyte in the first direction may be exposed to a surface of the fuel electrode.

According to an aspect of the present disclosure, a solid oxide cell includes: a fuel electrode; an air electrode; and an electrolyte disposed between the fuel electrode and the air electrode. The fuel electrode includes an array of pores embedded in the fuel electrode and spaced apart from each exterior surface of the fuel electrode.

The array of pores may include a pore having a shape in which a width narrows toward the electrolyte.

The array of pores may include pores spaced apart from each other in first and second horizontal directions of the fuel electrode such that the pores have a grid structure.

The array of pores may include pores spaced apart from each other in a first horizontal direction of the fuel electrode.

One of the pores may have a line shape extending in a second horizontal direction of the fuel electrode crossing the first horizontal direction.

One of the pores may have line portions extending in a second horizontal direction of the fuel electrode crossing the first horizontal direction, and connection portions connecting the line portions to each other and having a width greater than a width of the line portions.

The array of pores may include a first pore having a line shape extending in a first horizontal direction of the fuel electrode, and a second pore having a line shape extending in a second horizontal direction and crossing the first pore.

### BRIEF DESCRIPTION OF DRAWINGS

The above and other aspects, features, and advantages of the present disclosure will be more clearly understood from the detailed following description, taken in conjunction with the accompanying drawings, in which:

FIG. 1 is a perspective view schematically illustrating a solid oxide cell according to an exemplary embodiment in the present disclosure;

FIG. 2 is a cross-sectional view schematically illustrating a region of a solid oxide cell;

FIG. 3 is a cross-sectional view schematically illustrating a region of a solid oxide cell;

FIG. 4 is an enlarged view of a region of a fuel electrode;

FIG. 5 is an enlarged view of a region of an electrolyte;

FIG. 6 is an enlarged view of a region of an air electrode;

FIG. 7 is a cross-sectional view schematically illustrating a region of a solid oxide cell according to a modified example;

FIGS. 8 to 11 are cross-sectional views schematically illustrating regions of solid oxide cells according to modified examples, respectively;

FIGS. 12 to 14 schematically illustrate an example of a method of manufacturing a solid oxide cell; and

FIGS. 15 and 16 schematically illustrate another example of a method of manufacturing a solid oxide cell.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present exemplary embodiment, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

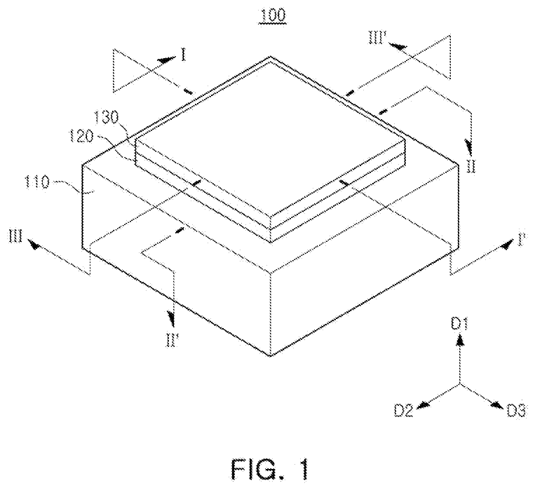

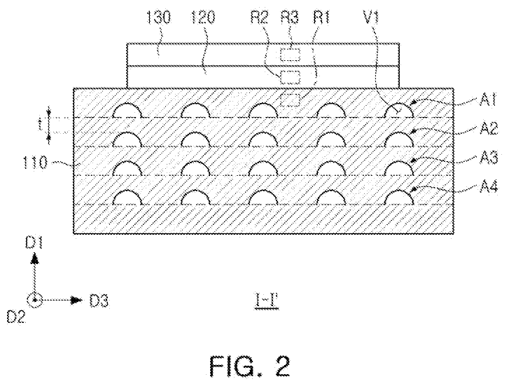

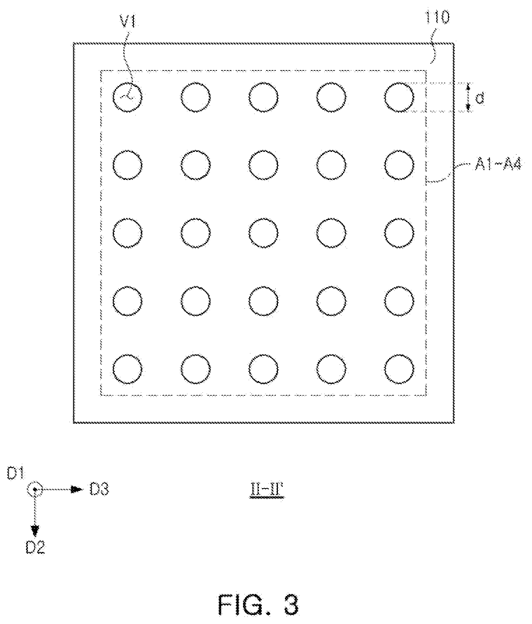

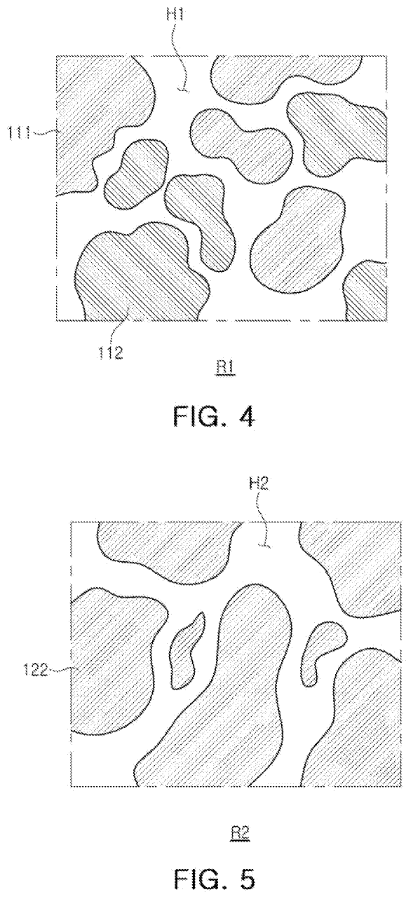

FIG. 1 is a perspective view schematically illustrating a solid oxide cell according to an exemplary embodiment in the present disclosure. FIGS. 2 and 3 are cross-sectional views schematically illustrating a region of a solid oxide cell. FIGS. 4 to 6 are enlarged views of regions of a fuel electrode, an electrolyte, and an air electrode, respectively.

Referring to FIGS. 1 to 3, a solid oxide cell 100 according to an exemplary embodiment in the present disclosure includes a fuel electrode 110, an air electrode 130, and an electrolyte 120 disposed therebetween, as main components. Here, the fuel electrode 110 includes a pore array A1 to A4 in which a plurality of pores V1 are arranged in a direction, perpendicular to a first direction D1, which is a thickness direction of the electrolyte 120, and in the fuel electrode 110, a plurality of pore arrays A1 to A4 are provided and arranged in the first direction D1. The regularly arranged pores V1 in the fuel electrode 110 may function as passages through which gas may flow in and out, and thus, reactivity within the solid oxide cell 100 may be improved. That is, a structure of the pores V1 may facilitate flow of gas in a lateral direction within the fuel electrode 110, and, in particular, when the solid oxide cell 100 is used as a solid oxide electrolysis cell (SOEC), the pores V1 may facilitate smooth flow of vapor, thereby contributing to the improvement of characteristics.

Hereinafter, components of the solid oxide cell 100 will be described in detail. The solid oxide cell 100 may be used as both a fuel cell and a water electrolysis cell. In the case of a water electrolysis cell mode, a reaction opposite to that of a case of a fuel cell may take place in the fuel electrode 110 and the air electrode 130 of the solid oxide cell 120. Specifically, when the solid oxide cell 100 is a fuel cell, for example, in the fuel electrode 110, water generation due to oxidation of hydrogen or an oxidation reaction of carbon compounds may occur, and in the air electrode 130, oxygen ion generating reaction may occur due to decomposition of oxygen. When the solid oxide cell 100 is a water electrolysis cell, the opposite reaction may occur. For example, hydrogen gas may be generated according to a reduction reaction of water in the fuel electrode 110, and oxygen may be generated in the air electrode 130. As another example, in the case of a fuel cell, a hydrogen decomposition (hydrogen ion generation) reaction may occur in the fuel electrode 110 and oxygen and hydrogen ions may be combined in the air electrode 130 to generate water, and in the case of a water electrolytic cell, decomposition of water (generation of hydrogen and oxygen ions) may occur in the fuel electrode 110, and oxygen may be generated in the air electrode 130. Also, in the electrolyte 120, ions may move to the fuel electrode 110 or the air electrode 130.

Referring to materials constituting the fuel electrode 110, the electrolyte 120, and the air electrode 130, first, as illustrated in FIG. 4, the fuel electrode 110 may include an electron conductor 111 and an ion conductor 112, each of which may be a sintered body of particles. The electron conductor 111 may perform an electrical conduction function and a catalytic function, and may include, for example, Ni-based, Co-based, or Cu-based metal or lanthanum chromite-based (La₁₋ₓSrₓCro₃, where 0≤x<1) material etc. The ion conductor 112 may include yttria-stabilized zirconia (YSZ)-based, ceria (Ceo₂)-based, bismuth oxide (Bi₂O₃)-based, lanthanum gallate (LaGao₃)-based materials, and the like. In addition, the fuel electrode 110 may be a porous body including random pores H1 having random shapes and arrangements, and the random pores H1 are distinguished from the regularly arranged pores V1. In the present exemplary embodiment, flow of gas in the fuel electrode 110 may be further improved and effectively controlled through the regularly arranged pores V1. That is, the random pores H1 may be formed in a manner in which a polymer-based pore forming agent is added and then removed by heat treatment during manufacturing of the fuel electrode 110, and tend to have high tortuosity and small diameter. In the case of using only the random pores H1, it may be difficult for gases having a low average moving distance and a low intrinsic diffusion coefficient, such as vapor, to flow smoothly, and in particular, it may be difficult to obtain smooth gas flow in a lateral direction (a direction, perpendicular to the direction D1), but this problem may be solved by using the pore arrays A1 to A4. Meanwhile, the dotted lines in FIG. 3 are to distinguish a region in which the plurality of pore arrays A1 to A4 are located, but the corresponding region is not always distinguished in the fuel electrode 110.

Referring to FIG. 5, the electrolyte 120 may be a sintered body of particles. The electrolyte 120 may be a porous body including random pores H2 through which gases, fluids, etc. may flow in and out. The electrolyte 120 may include the ion conductor 122, and a material constituting the ion conductor 122 may include, for example, stabilized zirconia. Specifically, the ion conductor 122 may include scandia stabilized zirconia (SSZ), yttria stabilized zirconia (YSZ), scandia ceria stabilized zirconia (SCSZ), scandia ceria yttria stabilized zirconia (SCYSZ), scandia ceria ytterbia stabilized zirconia (SCYbSZ) and the like.

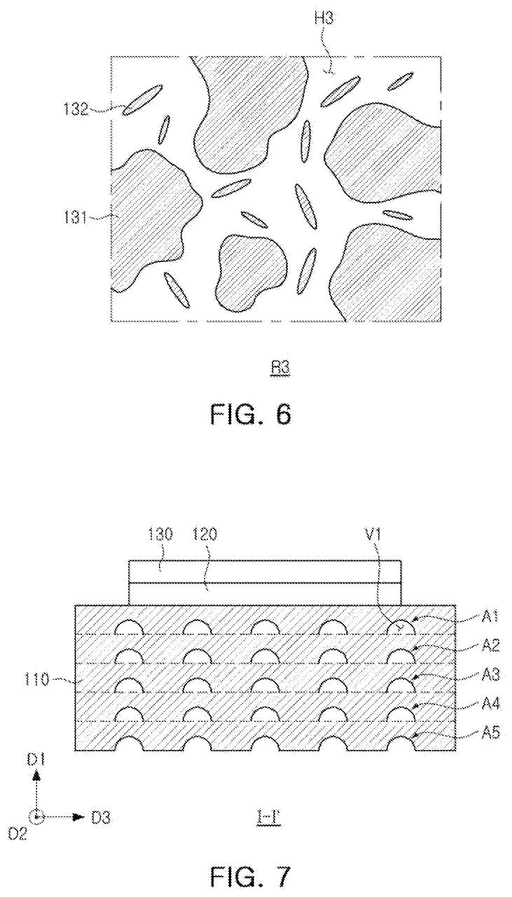

Referring to FIG. 6, the air electrode 130 may include an electron conductor 131 and an ion conductor 132, each of which may be a sintered body of particles. In the air electrode 130, the electron conductor 131 may include an electrically conductive material, such as an electrically conductive perovskite material, such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}N_{0.1}O₃ (LSCN), or metal such as Pt may also be used. The ion conductor 132 may include a material, such as yttria stabilized zirconia (YSZ), ceria (CeO₂), bismuth oxide (Bi₂O₃), or lanthanum gallate (LaGaO₃). The air electrode 130 may include about 10 wt % to about 90 wt % of the electron conductor 131 and about 10 wt % to about 90 wt % of the ion conductor 132, but depending on the exemplary embodiment, the air electrode 130 may not include the ionic conductor 132. As illustrated, the air electrode 130 may be a porous body including the random pores H3 through which gas, fluid, etc. may flow in and out.

Meanwhile, the solid oxide cell 100 according to the present exemplary embodiment may have a fuel electrode-supported structure in which the electrolyte 120 and the air electrode 130 are supported by the fuel electrode 110. In the case of the fuel electrode-supported solid oxide cell 100, a thickness of the electrolyte 120 is relatively thin, so resistance to ion movement may be reduced and power density may be improved, whereas the fuel electrode 110 is formed to be relatively thick, so a moving distance of gases may increase. The increase in the moving distance of gases in the fuel electrode 110 may lower supply uniformity of a reactant gas, especially when the solid oxide cell 100 functions as a water electrolytic cell, causing the degree of local electrochemical reaction to vary, which may cause structural deterioration of the solid oxide cell 100. Thus, in the present exemplary embodiment, by arranging the pore arrays A1 to A4 having the pores V1 regularly arranged in the fuel electrode 110, performance deterioration due to an increase in the moving distance of gases in the fuel electrode-supported solid oxide cell 100 may be reduced. However, the solid oxide cell 100 according to the present exemplary embodiment need not be used only as the fuel electrode supported structure and may also be used as an electrolyte 120 supported structure in which the fuel electrode 110 and the air electrode 130 are supported by the electrolyte 120.

The structure of the pores V1 of the fuel electrode 110 are described in more detail with reference to FIGS. 2 and 3. The plurality of pore arrays A1 to A4 include a plurality of pores V1 arranged in the second direction D2 and are arranged in the first direction D1. Here, the first direction D1 refers to a thickness direction of the electrolyte 120, and the second and third directions D2 and D3 refer to directions, perpendicular to the first direction D1, and perpendicular to each other. As described above, in the present exemplary embodiment, the plurality of pores V1 are arranged in the lateral direction (corresponding to D2) and the thickness direction (corresponding to D1) of the fuel electrode 110. In this case, as illustrated, the plurality of pores V1 in at least one of the plurality of pore arrays A1 to A4 may be arranged on substantially the same level with respect to the first direction D1. In addition, the plurality of pores V1 in at least one of the plurality of pore arrays A1 to A4 may be arranged in the third direction D3 to form a grid structure. In the present exemplary embodiment, an example in which all of the plurality of pore arrays A1 to A4 have the above structures is illustrated.

Regarding the shape of the pores V1, the plurality of pores V1 may include pores having a width in the second direction D2 or the third direction D3 narrowing toward the electrolyte 120 in the first direction D1, that is, upwardly, in the drawing. As a more specific example, the plurality of pores V1 may include pores having a shape in which the maximum length in the second direction D2 and the maximum length in the third direction D3 are substantially the same. As such, the plurality of pores V1 may include hemispherical pores.

The size and arrangement of the pores V1 may be determined in consideration of a level at which gas flows smoothly within the fuel electrode 110 and structural stability of the fuel electrode 110 is secured. For example, in the plurality of pore arrays A1 to A4, when a distance between adjacent pore arrays A1 to A4 in the first direction D1 is t and the maximum length of the pores V1 in the second direction D2 is d, the d may be greater than t, and furthermore, d may be twice or more than t. By arranging the pore arrays A1 to A4 at intervals t narrower than the size d of the pores V1, pore density in the fuel electrode 110 may be sufficiently increased, and even in this case, structural stability of the fuel electrode 110 may be maintained according to research by the present inventors. However, if the pores V1 are too large compared to the interval t of the pore arrays A1 to A4, the pores V1 may be very close to each other in the first direction D1 and the structural stability of the fuel electrode 110 may deteriorate. Therefore, in consideration of this, d may be set to a level of 10 times or less than t.

Three or more pore arrays A1 to A4 may be provided and regularly arranged in the first direction D1 so that sufficient pore density may be secured in the fuel electrode 110 and gases may more smoothly flow in the lateral direction. In the present exemplary embodiment, four pore arrays A1 to A4 are provided, and three or five or more pore arrays A1 to A4 may also be provided. Alternatively, only two pore arrays A1 to A4 may also be provided. Among the plurality of pore arrays A1 to A4, the pore array A1 closest to the electrolyte 120 in the first direction D1 may be spaced apart from the electrolyte 120 in the first direction D1, according to which the structural stability of the electrolyte 120 may be secured. In addition, in terms of securing the pore density of the fuel electrode 110, the pores V1 may not necessarily need to be exposed to the outside of the fuel electrode 110, and as illustrated, among the plurality of pore arrays A1 to A4, the pore array A4 farthest from the electrolyte 120 in the first direction D1 may be embedded in the fuel electrode 110. However, as in a modified example of FIG. 7, a pore array A5 farthest from the electrolyte 120 in the first direction D1, among the plurality of pore arrays A1 to A5, may be exposed to the surface of the fuel electrode 110. In this case, the pore array A5 farthest from the electrolyte 120 in the first direction D1, among the plurality of pore arrays A1 to A5, may be provided as a groove structure formed in a surface of the fuel electrode 110.

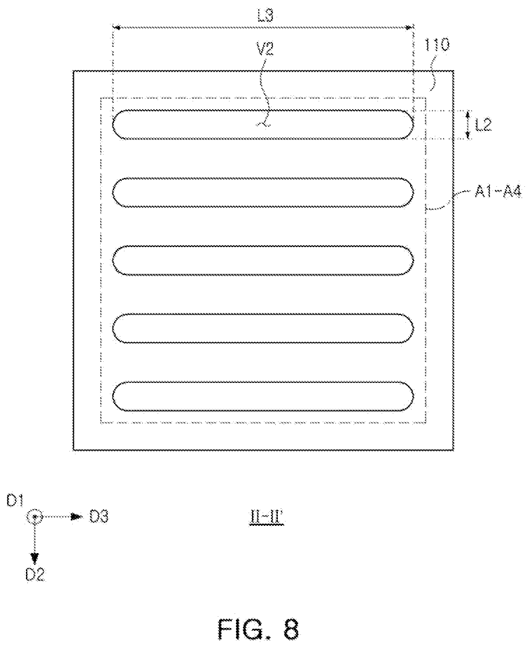

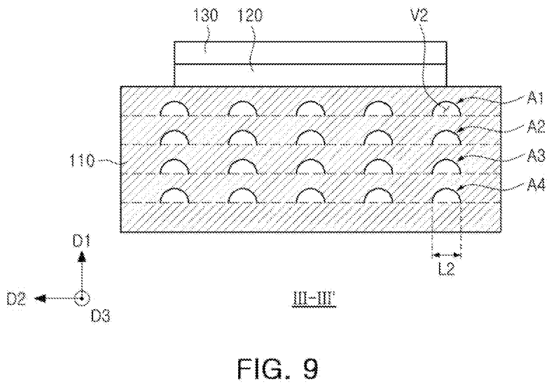

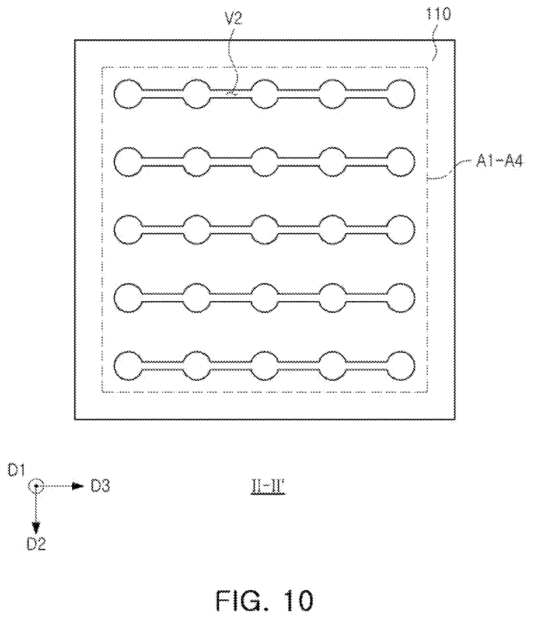

A form of pores that may be employed in a solid oxide cell according to a modified example will be described with reference to FIGS. 8 to 11. First, FIGS. 8 and 9 are cross-sectional views schematically illustrating a region of a solid oxide cell according to a modified example, which correspond to a II-II′ cross-sectional view and a III-III′ cross-sectional view, respectively. In the case of this modified example, a plurality of pores V2 has a line shape, through which gases may flow in the lateral direction more smoothly. Specifically, the plurality of pores V2 may include a first line pore V2 having a shape in which the maximum length L3 in the third direction D3 is twice or more than the maximum length L2 in the second direction D2. In this case, in at least one of the plurality of arrays A1 to A4, a plurality of first line pores V2 may be provided, and the plurality of first line pores V2 may be regularly arranged in the second direction D2. In FIG. 8, the first line pores V2 have a uniform length in the second direction D2, but are not limited thereto. That is, the length of the first line pores V2 in the second direction D2 may be relatively longer and shorter in a region. For example, as in the modified example of FIG. 10, the first line pores V2 may be implemented in a structure having a short length in the second direction D2 in a region, and in this shape, the pores V1 arranged in columns and rows in FIG. 3 to form a grid may be connected to each other.

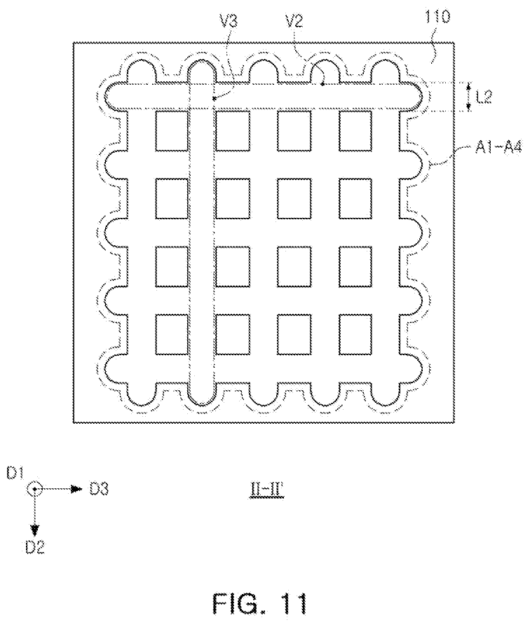

Next, in the case of a modified example of FIG. 11, a gas flow path in the lateral direction is further secured. Specifically, in at least one of the plurality of arrays A1 to A4, a plurality of pores V2 and V3 may include a second line pore V3 having a maximum length in the second direction D2 twice or more than the maximum length in the third direction D3, in addition to the first line pore V2. Here, a plurality of second line pores V3 may be provided, and the plurality of second line pores V3 may be regularly arranged in the third direction D3. In addition, the first line pores V2 and the second line pores V3 may cross each other and may contact each other in some regions to form an integral structure.

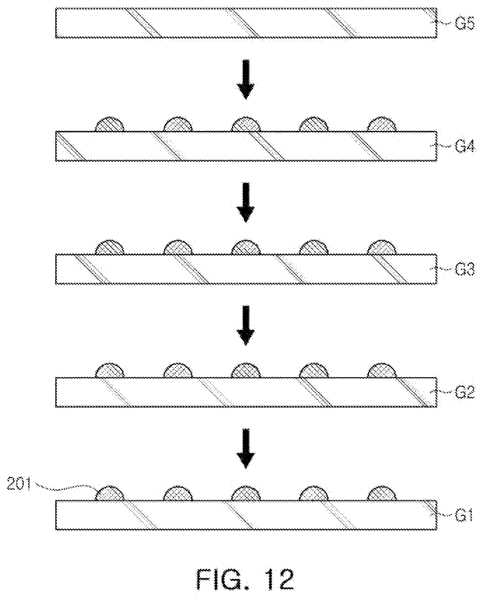

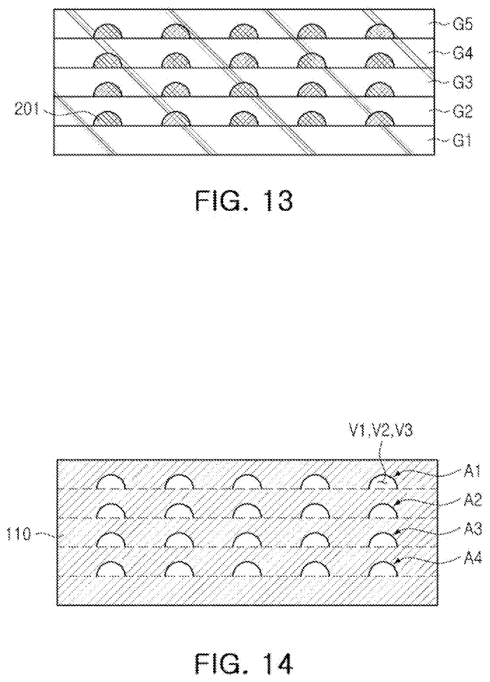

Hereinafter, an example of a method of forming the pores V1, V2, and V3 in the fuel electrode 110 will be described. FIGS. 12 to 14 schematically illustrate an example of a method of manufacturing a solid oxide cell, which is a method using a pore forming agent 201. First, a plurality of green sheets G1 to G5 are formed of an electrode material for manufacturing a fuel electrode, and the pore forming agent 201 is regularly formed on the surface thereof. In this case, the pore forming agent 201 may not be formed on the uppermost green sheet G5. The pore forming agent 201 may be a polymer-based material and may be formed to have the shape and arrangement of the pores V1, V2, and V3 of the exemplary embodiments described above. In the related art, when manufacturing the green sheets G1 to G5, random pores are formed by adding the pore-forming agent, but in the present exemplary embodiment, the pore forming agent 201 is applied to the surfaces of the green sheets G1 to G5 regularly. FIG. 13 illustrates a state in which the green sheets G1 to G5 are laminated, and FIG. 14 illustrates a state in which the pores V1, V2, and V3 are formed by removing the pore forming agent 201 after sintering.

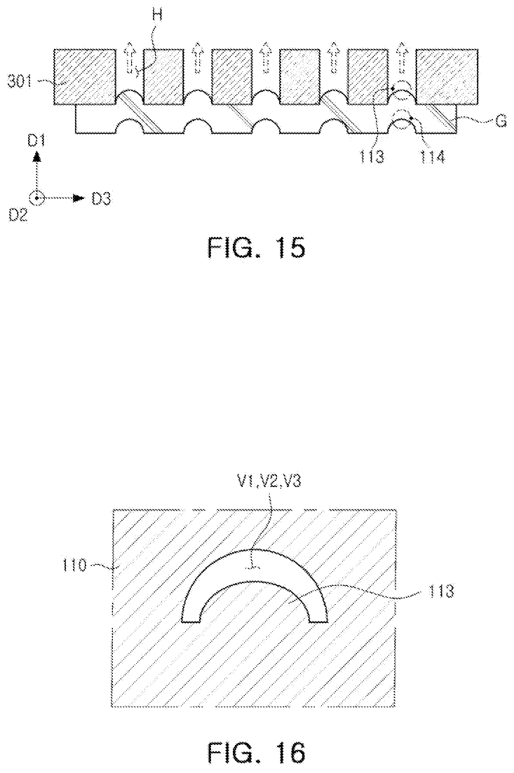

FIGS. 15 and 16 schematically illustrate another example of a method of manufacturing a solid oxide cell. In the case of the present manufacturing method, a plate 301 having holes H may be used, and a concave portion 114 for forming pores may be naturally formed in the process of adsorbing and transporting the green sheet G. Accordingly, a separate process of forming the pores V1, V2, and V3 may not be required, thereby improving process efficiency. Specifically, as illustrated in FIG. 15, the green sheet G is adsorbed through the holes H of the plate 301. After the plate 301 adsorbs the green sheet G, it is moved to and laminated on an intended region. In this process, a protrusion 113 may be formed in a region of the surface of the green sheet G adsorbed to the plate 301, and the concave portion 114 may be formed on the opposite side. In this case, in the lamination process, the protrusion 113 on the surface of the green sheet G may function as an index indicating a position in which the green sheet G to be laminated thereon is to be disposed. Therefore, when using the present manufacturing process, it may not be necessary to introduce a separate index for the lamination process, so process efficiency may be improved.

Meanwhile, the concave portion 114 of the green sheet G may remain after sintering to become the pores V1, V2, and V3. In addition, a height of the protrusion 113 of the green sheet G may be lowered during the lamination process, and depending on a lamination method, the protrusion 113 may not substantially exist after firing. Alternatively, the protrusion 113 may remain with a lowered height, and thus, as illustrated in FIG. 16 corresponding to an enlarged view of a partial area of the fuel electrode 110, the fuel electrode 110 may include a plurality of protrusions 113 partially filling the pores V1, V2, and V3 may be included. In this case, the protrusion 113 may overlap some of the plurality of pores V1, V2, and V3 in the first direction D1.

The solid oxide cell according to an example of the present exemplary embodiment may provide a smooth gas flow and thus have excellent reactivity. Therefore, performance may be improved when the solid oxide cell is used as a fuel cell or water electrolysis cell.

While example exemplary embodiments have been illustrated and described above, it will be apparent to those skilled in the art that modifications and variations could be made without departing from the scope of the present disclosure as defined by the appended claims.

What is claimed is:

1. A solid oxide cell comprising:
a fuel electrode;
an air electrode; and
an electrolyte disposed between the fuel electrode and the air electrode,
wherein the fuel electrode includes a plurality of pore arrays arranged in a first direction, one of the plurality of pore arrays including a plurality of pores arranged in a second direction, the first direction referring to a thickness direction of the electrolyte, and the second direction referring to a direction perpendicular to the first direction.

2. The solid oxide cell of claim 1, wherein, in the one of the plurality of pore arrays, the plurality of pores are also arranged in a third direction to form a grid structure, the third direction referring to a direction perpendicular to the first direction and the second direction.

3. The solid oxide cell of claim 1, wherein, in the one of the plurality of pore arrays, the plurality of pores are arranged on substantially the same level with respect to the first direction.

4. The solid oxide cell of claim 1, wherein the plurality of pores include pores having a shape in which a width in the second direction or a third direction narrows toward the electrolyte in the first direction, the third direction referring to a direction perpendicular to the first direction and the second direction.

5. The solid oxide cell of claim 1, wherein the plurality of pores include pores having a shape in which a maximum length in the second direction and a maximum length in a third direction are substantially the same, the third direction referring to a direction perpendicular to the first direction and the second direction.

6. The solid oxide cell of claim 5, wherein the plurality of pores include a hemispherical pore.

7. The solid oxide cell of claim 1, wherein the plurality of pores include a first line pore having a shape in which a maximum length in a third direction is twice or more a maximum length in the second direction, the third direction referring to a direction perpendicular to the first direction and the second direction.

8. The solid oxide cell of claim 7, wherein, in the one of the plurality of arrays, the first line pore is provided in plural, and the plurality of first line pores are regularly arranged in the second direction.

9. The solid oxide cell of claim 8, wherein, in the one of the plurality of arrays, the plurality of pores include a second line pore having a shape in which a maximum length in the second direction is twice or more a maximum length in the third direction.

10. The solid oxide cell of claim 9, wherein the second line pore is provided in plural, and the plurality of second line pores are regularly arranged in the third direction.

11. The solid oxide cell of claim 9, wherein the first line pore and the second line pore cross each other.

12. The solid oxide cell of claim 1, wherein the fuel electrode includes a protrusion partially disposed in the plurality of pores.

13. The solid oxide cell of claim 12, wherein the protrusion overlaps some of the plurality of pores in the first direction.

14. The solid oxide cell of claim 1, wherein d is greater than t, in which t is a distance between adjacent pore arrays in the first direction in the plurality of pore arrays and d is a maximum length of the pore in the second direction.

15. The solid oxide cell of claim 14, wherein d is equal to twice or more of t.

16. The solid oxide cell of claim 1, wherein the plurality of pore arrays are three or more pore arrays and are regularly arranged in the first direction.

17. The solid oxide cell of claim 1, wherein, among the plurality of pore arrays, a pore array closest to the electrolyte in the first direction is spaced apart from the electrolyte in the first direction.

18. The solid oxide cell of claim 1, wherein, among the plurality of pore arrays, a pore array farthest from the electrolyte in the first direction is embedded in the fuel electrode.

19. The solid oxide cell of claim 1, wherein, among the plurality of pore arrays, a pore array farthest from the electrolyte in the first direction is exposed to a surface of the fuel electrode.

20. A solid oxide cell comprising:
a fuel electrode;
an air electrode; and
an electrolyte disposed between the fuel electrode and the air electrode,
wherein the fuel electrode includes an array of pores embedded in the fuel electrode and spaced apart from each exterior surface of the fuel electrode.

21. The solid oxide cell of claim 20, wherein the array of pores include a pore having a shape in which a width narrows toward the electrolyte.

22. The solid oxide cell of claim 20, wherein the array of pores include pores spaced apart from each other in first and second horizontal directions of the fuel electrode such that the pores have a grid structure.

23. The solid oxide cell of claim 20, wherein the array of pores include pores spaced apart from each other in a first horizontal direction of the fuel electrode.

24. The solid oxide cell of claim 23, wherein one of the pores has a line shape extending in a second horizontal direction of the fuel electrode crossing the first horizontal direction.

25. The solid oxide cell of claim 23, wherein one of the pores has line portions extending in a second horizontal direction of the fuel electrode crossing the first horizontal direction, and connection portions connecting the line portions to each other and having a width greater than a width of the line portions.

26. The solid oxide cell of claim 20, wherein the array of pores include a first pore having a line shape extending in a first horizontal direction of the fuel electrode, and a second pore having a line shape extending in a second horizontal direction and crossing the first pore.
